(19) United States
(12) Patent Application Publication
(10) Pub. No.: US 2016/0146128 A1
(43) Pub. Date: May 26, 2016

(54) Vehicle Control System and Method of Using the Same

(71) Applicant: GM Global Technology Operations LLC, Detroit, MI (US)

(72) Inventors: Thomas H. Tu, Troy, MI (US); Thomas J. Stacey, Commerce Township, MI (US); Daniel R. Saylor, Sterling Heights, MI (US)

(21) Appl. No.: 14/553,071

(22) Filed: Nov. 25, 2014

(51) Int. Cl. F02D 37/02; F02P 5/15; F02D 41/02

(52) U.S. Cl. CPC F02D 37/02; F02D 41/0225; F02P 5/1502

(57) ABSTRACT

A vehicle control system and a method for extending the availability of certain vehicle systems that require mechanical output from an engine, such as power-assisted steering, braking, and vehicle acceleration following an unintended ignition event. In one embodiment, the method overrides ignition signals indicating an inactive ignition status and keeps the engine running if certain conditions are met. In another embodiment, the method attempts to automatically restart the engine while the vehicle is moving if the engine stops running, so long as certain conditions are met.

### FIELD

The present invention generally relates to a vehicle control system, and more particularly, to a method for operating a vehicle control system following an unintended ignition event.

### BACKGROUND

Some vehicle systems, such as certain types of power-assisted steering and braking systems, are only functional when a vehicle engine is running or operating.

Consider a hydraulic power-assisted steering system, for example, where hydraulic pressure is provided by a power steering pump that is mechanically coupled to and driven by the vehicle engine. The rotational position of a steering wheel, as dictated by a driver, controls a series of valves that connect pressurized hydraulic fluid from the power steering pump to an appropriate end of a slave cylinder whose piston is attached to a steering linkage. In this way, which is widely known and understood in the art, the power-assisted steering system helps the driver steer when the vehicle engine is running by supplementing their manual steering efforts and, thereby, making it easier to steer the vehicle. Other vehicle systems, like certain power-assisted braking systems or systems that rely on the output of an engine-driven alternator, may also need the vehicle engine to be running or operating in order to function.

Thus, it may be beneficial to provide a vehicle control system that seeks to automatically restart a vehicle engine or to keep a vehicle engine running following an unintended ignition event, so that vehicle systems that require engine operation are available during a wider array of circumstances.

### SUMMARY

According to one embodiment, there is provided a method of operating a vehicle control system. The method may comprise the steps: receiving a plurality of signals at a control module, the plurality of signals include speed signals that are representative of a vehicle speed, ignition signals that are representative of an ignition status, and engine signals that are representative of an engine status; evaluating the plurality of signals with the control module in order to detect an unintended ignition event, the unintended ignition event is detected when the ignition signals indicate a transition from an active ignition status to an inactive ignition status while the speed signals indicate the vehicle is moving and the engine signals indicate the engine is running; and preventing the engine from stopping in response to the detection of the unintended ignition event. Preventing the engine from stopping extends the availability of one or more vehicle systems that require engine operation.

According to another embodiment, there is provided a method of operating a vehicle control system. The method may comprise the steps: receiving a plurality of signals at a control module, the plurality of signals include speed signals that are representative of a vehicle speed, ignition signals that are representative of an ignition status, and engine signals that are representative of an engine status; evaluating the plurality of signals with the control module in order to detect an unintended ignition event, the unintended ignition event is detected when the speed signals indicate the vehicle is moving and the ignition signals indicate the ignition is active yet the engine signals indicate the engine is not running; and attempting to restart the engine while the vehicle is moving in response to the detection of the unintended ignition event. Restarting the engine restores the availability of one or more vehicle systems that require engine operation.

According to another embodiment, there is provided a method of operating a vehicle control system. The method may comprise the steps: receiving a plurality of signals at a control module, the plurality of signals include speed signals that are representative of a vehicle speed, ignition signals that are representative of an ignition status, and gear signals that are representative of a gear setting; evaluating the plurality of signals with the control module; when the control module determines that the vehicle speed is greater than a threshold and the ignition status is inactive and the gear setting is in drive, then attempting to restart the engine if it is not operating or keeping the engine running if it is already operating; and when the control module determines that the vehicle speed is greater than a threshold and the ignition status is active, then attempting to restart the engine if it is not operating or keeping the engine running if it is already operating.

### DRAWINGS

Preferred exemplary embodiments will hereinafter be described in conjunction with the appended drawings, wherein like designations denote like elements, and wherein:

FIG. 1 is a schematic view of a vehicle with an exemplary vehicle control system installed therein;

FIG. 2 is a flowchart of an exemplary method for operating a vehicle control system, such as the system of FIG. 1; and

FIG. 3 is a state diagram of an exemplary method for operating a vehicle control system, such as the method of claim 2.

### DESCRIPTION

The vehicle control system and method described herein can be used to automatically restart a vehicle engine or to keep a vehicle engine running following an unintended ignition event in order to extend or broaden the availability of certain vehicle systems that require engine operation. For example, if the vehicle engine unexpectedly stalls while the vehicle is being driven, the present system and method may automatically attempt to quickly restart the engine so that certain vehicle systems that require engine operation, like power-assisted steering and braking systems, can be restored as soon as possible. In a different example, such as when a minor collision jars an ignition unit and causes an unintended ignition event, the present system and method may override such actions and instead instruct the vehicle engine to keep running. Of course, the aforementioned examples only represent several of the possible circumstances that can potentially cause an unintended ignition event, as the system and method described herein could be used in response to any unintended ignition event and is not limited thereto.

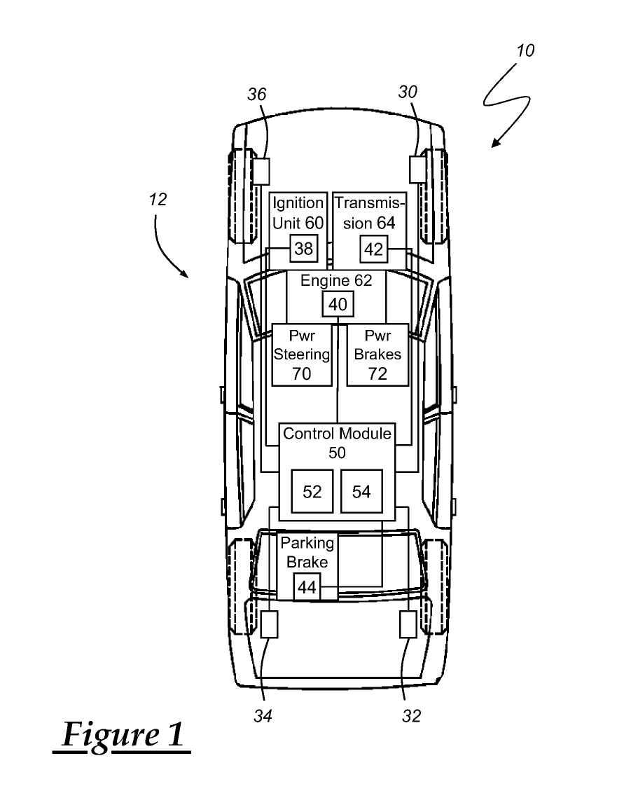

With reference to FIG. 1, there is shown a general and schematic view of an exemplary vehicle control system 12 installed on a vehicle 10. It should be noted that the following description is only one possibility, as the system and method described herein may be used with any type of vehicle and are not limited to the exemplary embodiments shown in FIG. 1. For example, the system and method may be used with a wide variety of vehicles, including trucks, sports utility vehicles (SUVs), crossover vehicles and cars, as well as vehicles with traditional internal combustion engines, hybrid electric vehicles (HEVs), plug-in hybrid electric vehicles (PHEVs), extended-range electric vehicles (EREVs), keyed ignition systems and keyless ignition systems, to name a few. According to one example, vehicle control system 12 may include vehicle sensors 30-44, control module 50, ignition unit 60, engine 62, transmission 64, and power-assisted vehicle systems 70, 72. Of course, the aforementioned list of system items is merely exemplary, as the actual combination of components, devices, modules, systems, etc. can vary from this exemplary embodiment.

Vehicle sensors 30-44 may provide vehicle control system 12 with information, data and/or other input that can be used by the present method. These include, for example, the exemplary sensors shown in FIG. 1, as well as other sensors that are known in the art but are not shown here. It should be appreciated that vehicle sensors 30-44, as well as any other sensor that is a part of and/or is used by system 12 may be embodied in hardware, software, firmware or some combination thereof. These sensors may directly sense or measure the conditions for which they are provided, or they may indirectly evaluate such conditions based on information provided by other sensors, components, devices, modules, systems, etc. Furthermore, sensors 30-44 may be directly coupled to control module 50, indirectly coupled to control module 50 via other electronic devices, or coupled according to some other arrangement known in the art. Sensors 30-44 may be integrated within another vehicle component, device, module, system, etc. (e.g., sensors that are already part of an ignition unit, an engine control module, a transmission control module, an electronic stability control system, antilock brake system, etc.), they may be stand-alone components (as schematically shown in FIG. 1), or they may be provided according to some other arrangement. In some instances, multiple sensors might be employed to sense a single parameter (e.g., for providing redundancy). It should be appreciated that the foregoing scenarios represent only some of the possibilities, as system 12 is not limited to any particular sensor or sensor arrangement and any suitable embodiment may be used.

Vehicle sensors 30-36 are speed sensors that generate speed signals representative of vehicle speed. Speed sensors 30-36 may utilize a variety of different sensors and sensing techniques, including those that use rotational wheel speed, ground speed, accelerator pedal position, gear position, shift lever position, accelerometers, engine speed, engine output, and throttle valve position, to name a few. Such information may similarly be available through an engine control module, a transmission control module, an anti-lock braking system (ABS), etc. In the example shown in FIG. 1, individual speed sensors 30-36 are coupled to each of the vehicle's four wheels and separately report the rotational velocity of the four wheels via speed signals. Skilled artisans will appreciate that these sensors may operate according to optical, electromagnetic or other technologies, and that other parameters may be derived or calculated from the speed readings, such as longitudinal or lateral acceleration. In another embodiment, vehicle sensors 30-36 determine vehicle speed relative to the ground by directing radar, laser and/or other signals towards known stationary objects and analyzing the reflected signals, or by employing feedback from a navigational unit that has Global Positioning System (GPS) and/or telematics capabilities. Vehicle sensors 30-36 may directly or indirectly send information to any of the control modules in the vehicle 10, including control module 50. It is also possible for a vehicle dynamics sensor to be installed within vehicle 10, such as under one of the front seats, so that it can sense lateral acceleration, yaw rate and other pertinent vehicle dynamics.

Vehicle sensors 38-44 are coupled to different components or parts of the vehicle and generate signals representative of their status. For example, vehicle sensor 38 is coupled to the ignition unit 60 and provides ignition signals that are representative of an ignition status. Vehicle sensor 40, on the other hand, is coupled to the engine 62 and generates engine signals that are representative or indicative of an engine status. Vehicle sensor 42 is coupled to the transmission 64 and provides the system with transmission signals representative of a transmission status, such as a current gear setting. As mentioned above, the vehicle sensors 38-44 may be combined, integrated and/or otherwise included within an ignition unit, an engine control module, a transmission control module, or some other type of device within the vehicle. Vehicle sensor 44 is a parking brake sensor and is coupled to the parking brake so as to provide the system with parking brake signals that indicate the status of the parking brake. It is not necessary that vehicle sensors 38-44 be separate, stand alone sensing elements as they are schematically depicted in FIG. 1.

Control module 50 is coupled to a number of the components and devices of the vehicle control system 12 so that the control module may receive inputs, process the inputs according to one or more of the processes described herein, then provide corresponding outputs. In terms of inputs, the control module 50 in the exemplary embodiment of FIG. 1 is coupled to and receives: speed signals from speed sensors 30-36, ignition signals from ignition sensor 38, engine signals from engine sensor 40, and transmission signals from transmission sensor 42. In terms of outputs, the exemplary control module 50 is coupled to and sends engine command signals to the engine 62. The control module 50 may be designed to carry out, execute and/or otherwise perform any combination of the method steps described herein and recited in the corresponding claims.

Control module 50 may include any variety of electronic processing devices, memory devices, input/output (I/O) devices, and/or other known components, and may perform various control and/or communication related functions. In an exemplary embodiment, control module 50 includes an electronic memory device 52 and an electronic processing device 54. The electronic memory device 52 can store various sensor readings (e.g., sensor readings from sensors 30-44), look up tables or other data structures, algorithms (e.g., the algorithm that embodies or performs the exemplary methods described below), etc. Control module 50 may also include an electronic processing device 54 (e.g., a microprocessor, a microcontroller, an application specific integrated circuit (ASIC), etc.) that executes instructions for software, firmware, programs, algorithms, scripts, applications, etc. that are stored in memory device 52 and may govern the methods described herein. Control module 50 may be electronically connected to other vehicle devices, modules, and systems via suitable vehicle communications and can interact with them when required.

Depending on the particular embodiment, control module 50 may be a stand-alone vehicle electronic module (e.g., an ignition control module, engine control module, power master ECU, etc.), it may be incorporated or included within another vehicle electronic module, or it may be part of a larger network or system (e.g., an active safety system, an engine management system, etc.), to name a few possibilities. Of course, other connections, arrangements, functions, capabilities, etc. are certainly possible, as the aforementioned description of the control module 50 is only meant to serve as examples of potential embodiments, as the control module may be arranged and connected in any number of different configurations. Accordingly, the control module 50 is not limited to any one particular embodiment or arrangement and may be used to perform or carry out one or more aspects of the present method.

Ignition unit 60 may include any combination of ignition components including an ignition switch, an electronic ignition module, an ignition coil and/or other suitable ignition components known in the art. In a keyed ignition system, the ignition unit 60 typically requires a key (not shown) to unlock a switch mechanism in an ignition lock cylinder, and is often coupled with a starter switch for activating a starter motor. A standard keyed ignition typically has four positions: an ‘OFF’ position, an accessory or ‘ACC’ position, an ‘ON’ or run position, and a ‘START’ or crank position; these positions may vary, however, and need not have the same combination or be in any particular order. For example, it may be possible for the ‘OFF’ position to be located between the ‘ACC’ position and the ‘ON’ position, or there may be no ACC position all together, or there may be additional positions such as a lock position, to cite a few possibilities. In a standard keyless ignition, there may only be two ignition states: active and inactive, as most keyless systems do not have ACC and START ignition positions. In the particular example illustrated in FIG. 1, the ignition unit 60 controls some of the main electrical systems in the vehicle, including those related to starting the engine 62, related to ignition timing, and related to electrical accessories within the vehicle, and the ignition unit (which may include an ignition control module sensors) provides ignition signals to the control module 50 that are representative of the ignition status.

The ignition status generally pertains to the position or state of the ignition switch (e.g., OFF, ACC, ON, START) and, in terms of a vehicle with a standard internal combustion engine and a keyed ignition, the ignition positions OFF and ACC are considered ‘inactive’ and the ignition positions ON and START are considered ‘active’. For ease of explanation, the term ‘inactive’ will be used to broadly refer to any ignition position where the main vehicle propulsion system is not activated. In the case of vehicles having a traditional internal combustion engine as the main propulsion source, the term ‘inactive’ refers to an ignition position where a starter has not yet started the internal combustion engine and typically includes the OFF and ACC positions. In terms of battery electric vehicles (BEVs), hybrid electric vehicles (HEVs), plug-in hybrid electric vehicles (PHEVs), extended range electric vehicles (EREVs), or any other vehicles that primarily use an electric motor as the main source of propulsion, the term ‘inactive’ refers to an ignition position where the main electrical contactors in the vehicle are open or have not been energized. Conversely, the term ‘active’ broadly refers to any ignition position where the main vehicle propulsion system is activated. For vehicles with traditional internal combustion engines as the main source of propulsion, the term ‘active’ refers to an ignition position where a starter has already started the internal combustion engine or is in the process of starting the engine. Typically, active includes the ON and the START positions. For BEVs, HEVs, PHEVs, EREVs or any other vehicles that primarily use an electric propulsion system, the term ‘active’ refers to all ignition positions where the main electrical contactors are closed or have been energized.

As mentioned above, the present system and method may also be used with keyless ignition systems, which oftentimes include a hand-held fob containing a radio transceiver that communicates with a transceiver on the vehicle. According to one exemplary embodiment, when the transceiver on the vehicle detects an authorized fob within a certain predetermined zone, the driver may start the vehicle by simply activating the ignition switch, such as by pressing a button. Other examples and embodiments of keyed and keyless ignition systems, including those using remote start features, may also be used. The present description is provided in the context of a keyed ignition system for a traditional internal combustion engine; however, it should be appreciated that the system and method described herein are not so limited and may easily be used with other systems and in other applications as well.

Engine 62 produces a rotational force or torque that is used to propel the vehicle, and may include any suitable type of engine known in the art. Some examples of suitable engines include gasoline, diesel, ethanol, flex-fuel, naturally aspirated, turbo-charged, super-charged, rotary, Otto-cycle, Atkins-cycle and Miller-cycle engines, as well as any other suitable engine type known in the art. According to the exemplary embodiment shown in FIG. 1, engine 62 further includes an engine control module with one or more engine sensors 40 that are coupled to the control module 50 to provide it with engine signals that are representative of an engine status (e.g., is the engine running or stopped). In addition, the engine 62 is mechanically and/or hydraulically coupled to the transmission 64, the power steering unit 70, and the power brake unit 72, as is well known in the art. Skilled artisans will appreciate that engine 62 may be provided according to any number of different embodiments, may be arranged in any number of different configurations.

Transmission 64 transmits the output of the engine to the rest of the drivetrain, and may include any suitable type of transmission known in the art. Transmission 64 may be part of a front-, rear-, all- or four-wheel drive, a manual or an automatic transmission, for example, and is mechanically coupled to the engine 62. In the example of FIG. 1, the transmission 64 includes some type of transmission control module with one or more transmission sensors 42 that are coupled to control module 50 and provide it with transmission signals that are representative of a transmission status (e.g., the gear selection like park, reverse, neutral, drive, low, etc.). The particular type and arrangement of the transmission 64 is not imperative, in terms of the present method, so long as the vehicle control system 12 is able to determine the status or state of the transmission.

Power steering unit 70 and power braking unit 72 are examples of power-assisted vehicle systems that require the mechanical output of the engine in order to operate. For instance, the power steering unit 70 (which is sometimes referred to as a power assisted steering or steering assist system) may rely on hydraulic pressure provided by a power steering pump that is mechanically coupled to and driven by the engine 62 to operate. Similarly, the power braking unit 72 uses a vacuum provided by vacuum pump mechanically coupled to the engine 62 and a brake booster to increase the force that is exerted by the foot of the driver to the master brake cylinder. In each of these instances, the power-assisted vehicle system relies upon the mechanical output of the engine 62 and will not function without it. Accordingly, when the engine 62 is stopped so that it is no longer running, the power steering unit 70, the power braking unit 72 and/or any other vehicle systems that use mechanical output from the engine, like an engine driven alternator, will likely stop working. Power steering unit 70 and/or power braking unit 72 may include their own dedicated control module (e.g., a steering control module, a brake control module, etc.), or they may share or utilize some other control unit or module in the vehicle. It should be appreciated that the method described herein is not limited to any particular type or combination of power-assisted vehicle systems, and can be used with a variety of such units or systems.

Again, the preceding description of exemplary vehicle control system 12 is only intended to illustrate one potential embodiment, and the following methods are not confined to use with only that system. Any number of other system arrangements, combinations and architectures, including the system shown in FIG. 1 described above, as well as others that differ significantly from the ones disclosed herein, may be used instead.

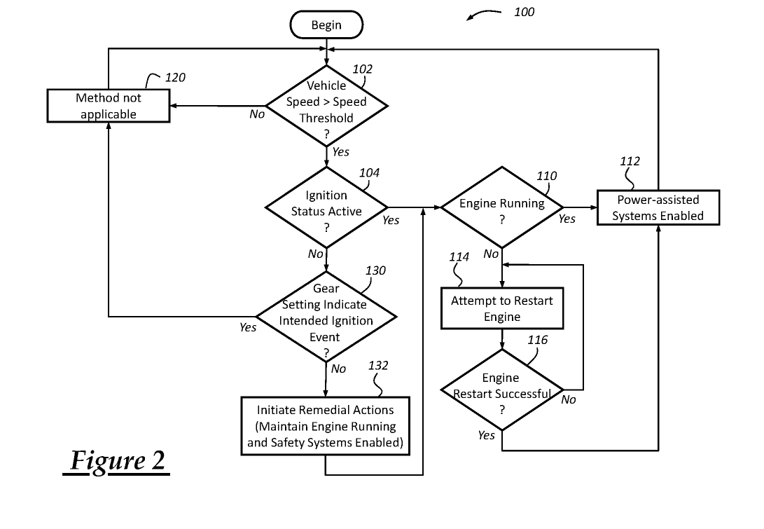

Turning now to FIG. 2, there is shown an exemplary method 100 that may be used with the vehicle control system 12 to extend or broaden the availability of certain vehicle systems that rely upon engine operation, such as power-assisted steering and braking systems, so that such systems are available following an unintended ignition event. Consider the examples where the vehicle is being driven and the vehicle engine 62 unexpectedly stalls or, separately, where the ignition unit 60 inadvertently sends an ignition signal instructing the vehicle engine to stop operating. If unaddressed, these events will likely lead to one or more of the power-assisted systems 70, 72 becoming unavailable, as such systems rely upon the mechanical output of the engine to operate. The present method may be used to expand the availability of such vehicle systems under circumstances where the engine would otherwise be turned off. The preceding examples are not the only circumstances where a vehicle may experience an unintended ignition event where the present system and/or method may be useful, as others certainly exist.

Beginning with step 102, the method determines if the vehicle speed is greater than a minimum speed threshold. Most of the methodology described below is directed to instances where the vehicle is being driven and is, therefore, traveling at a speed greater than some minimum speed threshold (e.g., greater than 0, 1, 3 or 5 m.p.h.). According to one potential embodiment, the speed sensors 30-36 provide the control module 50 with speed signals that are representative of a vehicle speed (e.g., an instantaneous vehicle speed, an average vehicle speed, or some other suitable vehicle speed reading or parameter), and the control module 50 compares the vehicle speed to a minimum speed threshold that is stored in memory 52. In other embodiments, the control module 50 may obtain speed signals representative of vehicle speed from the engine 62 (e.g., from an engine control module operably coupled to the engine), from other control modules or controllers located throughout the vehicle (e.g., ABS, stability or traction control modules or navigation unit), or from various sensors in the vehicle, and the control module 50 compares a vehicle speed determined from these speed signals to a minimum speed threshold. The minimum speed threshold generally delineates when the vehicle is considered stopped versus when it is considered moving. Vehicle acceleration and/or deceleration may also be taken into account when selecting or establishing the minimum speed threshold, so that a greater threshold could be used in instances where the vehicle is experiencing a significant deceleration which indicates that the driver is in the process of bringing the vehicle to a stop, even if it is not at a complete stop yet. If the vehicle speed is not greater than the minimum speed threshold (i.e., the vehicle is considered stopped), then the method could simply proceed to step 120 and back to step 102 for continued monitoring; if, on the other hand, the vehicle speed is greater than the minimum speed threshold (i.e., the vehicle is considered moving), then the method may continue for further processing.

Skilled artisans will appreciate that vehicle speed may be determined in any number of different ways. For example, vehicle acceleration, wheel speed, inertial sensor information, GPS information, brake system information, as well as any other input or information pertaining to vehicle dynamics may be used to determine vehicle speed. In addition, the present method may use readings or information pertaining to various parts of the vehicle drivetrain to determine the vehicle speed; these may include, for example, engine speed, gear or shaft rotation, as well as any other input from the vehicle drivetrain indicating that the vehicle is moving at a certain speed. If the method relies on an engine control module or the like to provide the speed signals, as in one of the embodiments described above, and that module becomes disabled due to the engine stalling or the ignition status becoming inactive, the method may use the last saved speed signals. For any piece of data or information that is obtained from a module that could become disabled in response to an engine stall or an unintended ignition event, it may be beneficial to verify that data with a time stamp. If other control modules, such as a brake control module, typically remain operable or enabled despite an inactive ignition status, then the method may choose to receive the speed readings from such devices. Accordingly, step 102 may use any known technique for determining vehicle speed, including ones not disclosed herein.

Step 104 determines if the ignition status is active or inactive, and may do so in any number of different ways. For example, it is possible for the control module 50 to query the ignition unit 60 in order to determine whether the current ignition status is active or inactive. In a different embodiment, the ignition unit 60 reports and/or the control module 50 detects a change in ignition status and, in response to the change, determines if the ignition status is transitioning to an active or inactive state. This may be performed by monitoring the actual ignition position of the ignition switch (e.g., OFF, ACC, ON, START), or it may be performed by simply querying the unit to determine if it is active or inactive. As mentioned above, in terms of a vehicle with a standard internal combustion engine and a keyed ignition, the ignition positions OFF and ACC (or equivalent positions) are considered ‘inactive’ and the ignition positions ON and START (or equivalent positions) are considered ‘active’. In a keyless system, there may only be two different ignition statuses or states: active and inactive, as most keyless systems do not have ACC and START ignition positions. According to one embodiment, one or more sensors 38 in the ignition unit 60 provide the control module 50 with an ignition signal that is representative of the status or state of the ignition unit and may be used to determine if the ignition status is active or inactive. It should be appreciated that any suitable method or technique may be used to determine or obtain the ignition status, including the exemplary ways mentioned above as well as other ways that are used with vehicles having keyed ignition systems, keyless ignition systems, hybrid electric propulsion systems, and remote starters, to name a few. If the ignition system is active (e.g., an ignition position of ON, START, etc.), then the method proceeds to step 110; if the ignition status is inactive (e.g., an ignition position of OFF, ACC, etc.; this includes when the ignition system transitions from active to inactive), then the method may continue to step 130.

Next, step 110 determines if the engine is currently running or is stopped. For example, similar to the previous step, it is possible for the control module 50 to directly query or otherwise obtain the present operating status of the engine from the engine 62 or a control module coupled thereto, or those components could send a signal to the control module 50 any time the engine status changes. According to an exemplary embodiment, one or more sensors 40 in the engine 62 send an engine signal to the control module 50 that is representative of the status or state of the engine and, at a minimum, indicates whether or not the engine is running. The engine is considered “running” when the internal parts of the engine are moving, and this includes both idling and non-idling states. It should be noted that if the vehicle speed is greater than the minimum speed threshold (i.e., the vehicle is moving) and the ignition status is active (e.g., ignition position corresponding to ON or START), it is normally expected that the engine will be running or operating. Thus, step 112 simply represents normal operating conditions where the various power-assisted systems (e.g., power-assisted steering system 70 and power-assisted braking system 72) are presumably enabled and operational. It is also expected that different safety related systems or features, like airbags and seat belt tensioners, would be enabled and operational at step 112. Following step 112, the method could simply loop back to step 102 for continued monitoring.

If step 110 determines that the engine is not running or is stopped, then the method proceeds to step 114 where it attempts to restart the engine while the vehicle is moving at some vehicle speed. As described above, this particular combination of conditions—a vehicle speed greater than a minimum speed threshold and an engine status that is stopped or off—is generally considered undesirable and can be the result of the engine stalling or experiencing some other malfunction. Step 114 attempts to quickly restart the engine while the vehicle is at speed so that operation of the different power-assisted systems can be automatically restored as soon as possible, and may do so in a variety of different ways. According to one example, the control module 50 sends ignition command signals to the ignition unit 60 that cause a solenoid/starter motor to try and engage and restart the engine 62 as the vehicle is being driven. This may also be accomplished directly or indirectly by sending ignition command signals through an engine control module or some other suitable vehicle component.

After attempting to restart the engine, the method may optionally employ another check to ensure that the engine restart procedure was actually successful, step 116. If the engine 62 is running, then the restart attempt must have been successful so that the method progresses to the normal operating conditions step 112, where the power-assisted steering and braking systems 70, 72 are presumably operating properly. However, if the engine is not running or is still off at step 116, then the method will keep trying to restart the engine until, for example, an affirmative action is taken by the driver indicating their desire to maintain the engine off or stopped (e.g., by placing the vehicle gear in park or neutral or turning the ignition to an inactive status). In another example, the method uses a counter that counts or tracks the number of restart attempts, and once the counter exceeds some restart attempt threshold, the method stops trying to restart the engine and sends one or more error messages in response thereto (e.g., an error messages sent to the driver via a user interface of some type, or an error message in the form of a diagnostic trouble code (DTC)).

Returning to step 104, if it is determined that the ignition system is inactive (e.g., ignition position corresponding to OFF or ACC), the method will attempt to keep the engine running while determining if an unintended or an intended ignition event has occurred. By keeping the engine running during this period, certain power-assisted features like power-assisted steering and braking, as well as other features that rely on alternator power will continue to be available to the driver. By way of example, it is possible for the vehicle 10 to strike a piece of debris in the road or to be involved in a minor collision where the resulting impact jars or jolts the ignition unit 60 in a manner that causes it to mistakenly interpret the ignition status as inactive and to send out a correspondingly inaccurate ignition signal. In a different example, a child or other passenger could suddenly grab or turn the key in the ignition unit 60 so that the ignition status abruptly and undesirably changes to an inactive status before the driver has time to intervene. These are non-limiting examples of unintended ignition events that the method seeks to identify and address.

At step 130, the method determines if the gear setting indicates an intended ignition event. During an intended ignition event where the driver purposely makes the ignition status inactive (e.g., by turning the key to OFF in a typical manner), it is expected that the driver will bring the vehicle to a stop and then select a gear setting of park, neutral or reverse (in some instances, the driver may engage a parking brake). Thus, the combination of steps 102, 104 and/or 130 are designed to distinguish between unintended and intended ignition events, but may keep the engine running in the interim while this determination is being made. According to one embodiment, step 130 receives a transmission signal from one or more sensors 42 that is representative of the gear setting or shift lever position of the transmission (e.g., park, reverse, neutral, drive, low, etc.). Skilled artisans will appreciate that manual transmissions typically do not have a park setting, and that drivers may engage a parking brake when parking a vehicle with a manual transmission. If step 130 determines that the vehicle is in park, neutral or reverse and/or that the parking brake has been engaged, the method assumes that the inactive ignition status was in fact intended and caused by the driver; thus, the method proceeds to step 120, as further intervention is probably not necessary. It is generally expected that the vehicle will not be in park at step 130, since step 102 already determined that the vehicle was moving, but this step could provide redundancy to the system in the event that some of the sensors or other equipment has malfunctioned. If the vehicle is not in park, neutral or reverse and the parking brake has not been applied, step 130 determines that an unintended ignition event has probably occurred and that the ignition unit 60 has inadvertently sent an inactive ignition signal. If such a situation occurs, the method can proceed to step 132 to initiate remedial actions. It is possible for step 130 to simply determine if the vehicle gear setting is in park, as opposed to determining if it is in park, neutral or reverse.

It should be appreciated that step 130 may include additional or different steps, other than those described above, for determining when an unintended ignition event has occurred. The preceding steps may be used to identify situations where the ignition status is inactive, even though the vehicle is still moving and is still in drive, so that the method may temporarily override the unintended ignition event that would otherwise stop the engine and disable certain power-assisted features, such as power-assisted steering and braking. Thus, any other signals, inquiries and/or other factors that may be used to help identify unintended ignitions events may also be employed by the method. Once such example involves the use of door sensors, occupant seat sensors and/or any other sensors that may determine if one or more occupants are still in the vehicle. If these different sensors indicate that all of the occupants have left the vehicle, then step 130 may direct the method to step 120, as further intervention by the method may be unnecessary. If these sensors indicate that one or more occupants are still inside the vehicle, then the method may proceed to step 132 to begin a series of remedial actions. Again, other inquiries or steps could also be used.

In step 132, the method maintains the engine running and/or initiates other remedial actions, even though the ignition unit 60 or other sensors may be indicating that the ignition has been turned off (i.e., an inactive ignition status). In one particular embodiment of step 132, the control module 50 overrides, intervenes and/or otherwise prevents the vehicle from turning off the engine 62 in response to an unintended ignition event, regardless of how it was caused. This could be carried out in a number of ways, including structuring the software, firmware and/or hardware of the present method in a way that requires all requests to shut down or turn off the engine to pass through the series of precautionary steps described herein so that unintended ignition events are identified and prevented from turning off the engine while the vehicle is moving. In this way, control module 50 or some other device carrying out the present method may be able to intercept command signals resulting from unintended ignition events so that the vehicle engine 62 remains running and providing mechanical output to power-assisted vehicle systems, like the power-assisted steering and braking systems 70, 72. Appropriate modifications are envisioned for vehicles with manual transmissions, such as automatically engaging a clutch, etc. Of course, maintaining the engine running is not the only remedial action contemplated by the present invention.

It is also possible for step 132 to maintain or keep enabled one or more vehicle safety systems, like supplemental inflation restraints (SIR) or airbags, or to issue one or more warnings, to cite a few possibilities. In some vehicle safety systems, the airbags are enabled and ready for deployment whenever the ignition status is active (e.g., whenever the key is in the ON position). Thus, step 132 could be designed to override the unintended ignition event and provide a command signal to an airbag control module or other device that instructs it to remain enabled and operational even though the ignition unit 60 could be sending a signal indicating that the key is in the OFF or ACC position. As part of this step, a variety of different control modules or units could continue to be powered (e.g., an airbag control module, a steering control module, a brake control module, etc.). It is also possible for step 132 to issue one or more visual, audible, haptic and/or other warnings or messages to the driver, alerting them to the unintended ignition event and, perhaps, giving them a chance to manually override the remedial actions. Such a feature would allow the driver to intervene and manually shut off the engine, if that is the driver's intent. For example, a message indicating that an unintended ignition event has likely occurred could be provided to the driver via a dash panel or heads up display, at which point the driver could confirm the ignition status by turning the key to OFF, putting the vehicle in park, or performing some other action that confirms that he or she does, in fact, wish to turn off the engine. If the driver provides such a confirmation, the engine could be turned off so that it is no longer running, assuming that doing so is safe and appropriate.

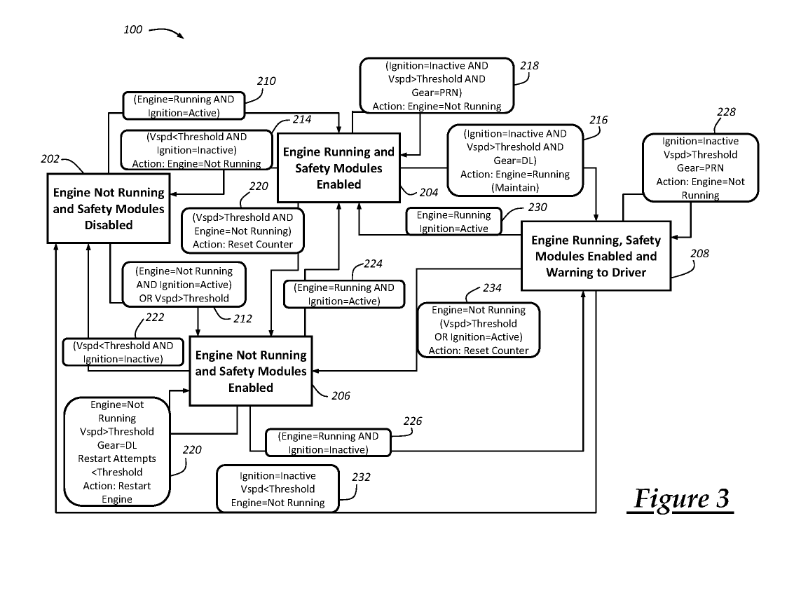

Following step 132, the method could return to step 110 for confirmation that the engine is in fact still running, or it could alternatively loop back to step 102 or elsewhere for continued monitoring. It should be understood that method 100 is merely an illustration of one exemplary embodiment, and that other embodiments with different sequences and combinations of steps, as well as ones with different logic flows may be used instead. For example, FIG. 3 shows a more detailed version of the present method 100, but in the form of a state diagram.

The state diagram illustrated in FIG. 3 encompasses or includes four possible states: state 202—where the engine is not running and one or more safety module(s) are disabled (e.g., when the vehicle is not being operated); state 204—where the engine is running and one or more safety module(s) are enabled (e.g., when the vehicle is being operated under normal operating conditions); state 206—where the engine is not running, yet one or more safety module(s) are enabled (e.g., when the engine stalls but the vehicle is still in gear); and finally, state 208—where the engine is running, one or more safety module(s) are enabled, and a warning is issued to the driver (e.g., when an unintended ignition event occurs). Transition conditions 210-234 describe various conditions or actions that trigger a movement from one state to another. It should be understood that FIG. 3 is described in the context of a vehicle with an internal combustion engine, although vehicles with other propulsion systems may be substituted and the various states and transition conditions could be adjusted accordingly. The capitalized words AND and OR are used below to denote Boolean relationships of certain exemplary embodiments, but the method is not limited to these specific examples and may be embodied in other embodiments as well.

Beginning with the normal operative state 202 where the engine is not running and one or more safety module(s) are disabled, there are two transition conditions that may shift the method to a different state. Transition condition 210 requires the engine to be running AND the ignition status to be active, and could be a result of the driver simply starting the vehicle according to a normal starting procedure. This transition condition would shift the method from state 202 to state 204, where the engine is running and one or more safety module(s) are enabled (e.g., a normal operating state). Transition condition 212 encompasses two possibilities, either one of which will switch the method from state 202 to state 206. A first possibility requires the engine to not be running AND the ignition status to be active, and a second possibility simply requires the vehicle speed to be greater than a minimum speed threshold. Thus, transition condition 212 is satisfied if the first possibility OR the second possibility is fulfilled.

Starting from the normal operative state of 204, where the engine is running and one or more safety module(s) are enabled, there are various transition conditions that may shift the method to a different state. For example, transition condition 214, which requires the vehicle speed to be less than a minimum speed threshold AND the ignition status to be inactive, indicates that the driver probably intended to bring the vehicle to stop and turn it off causes the method to shift to normal operative state 202, where the engine is not running and one or more safety module(s) are disabled. If the vehicle speed is greater than the minimum speed threshold AND the ignition status is inactive, transfer conditions 216, 218 may trigger various actions depending on the gear setting or position. For example, in condition 216, which involves the ignition status being inactive AND the vehicle speed being greater than the threshold AND the gear setting being in drive or low, a shift would occur from state 204 to state 208. In state 208, the engine is running, one or more safety module(s) are enabled, and a warning is issued alerting the driver of the somewhat unusual set of circumstances where the engine is running, yet the ignition is inactive. If the vehicle speed decreases to below the minimum speed threshold, an action command would be issued to stop the engine, as this scenario would be indicative of an intended ignition event. In transfer condition 218, the ignition is inactive AND the vehicle speed is greater than the threshold AND the vehicle gear is in a non-driving setting (e.g., park, reverse, or neutral). This set of circumstances suggests that an intended ignition event has occurred because the driver would have shifted into park, reverse, or neutral, in addition to the ignition being switched to inactive. In such a situation, an action command could be issued to stop the engine.

Transition condition 220 encompasses a scenario where, starting from normal operative state 204, the vehicle speed is greater than the minimum speed threshold AND the engine is no longer running. This set of conditions would shift the method to step 206 where the engine is not running but one or more safety module(s) are still enabled and may occur, for example, if the engine stalls. If transition condition 220 occurs, an action command may be issued to reset a restart counter to try and restart the engine. In such a scenario, because the vehicle is traveling at a speed above the threshold despite the inoperative status of the engine, it is desirable to have certain vehicle systems available, such as power-assisted steering and braking systems. Accordingly, so long as the ignition is active AND the speed is above the threshold while the engine is not running, the method will attempt to restart the engine.

As previously mentioned, state 206 involves a scenario where the engine is not running but one or more safety module(s) are enabled. From here, so long as the engine remains stopped or not running AND the vehicle speed is greater than the threshold AND the vehicle gear is in drive or low, transition condition 220 will issue an action command to attempt to restart the engine so long as the number of restart attempts is less than a restart threshold. However, it should be recognized that a restart threshold is not necessary, or may take different forms, such as a restart timer, which will keep trying to restart the engine for a certain amount of time. Other criteria could be used as well to govern the engine restart procedure, as described above.

There are various transition conditions that could shift the method from state 206 to another state. If, while the engine is stopped, the vehicle speed decreases to below the minimum speed threshold AND the ignition status is inactive or becomes inactive, then transition condition 222 can cause the method to change from state 206 to state 202, which is a normal operative state where the engine is stopped and one or more safety module(s) are disabled. If attempts to restart the engine are successful, then transfer conditions 224, 226 involve transitions from state 206 to states 204, 208, respectively, depending on the ignition status. For instance, transition condition 224 involves a scenario where the engine is running AND the ignition status is active (i.e., a normal set of circumstances), so the method transitions back to the normal operative state 204. However, if the engine is running AND the ignition status is or becomes inactive, transition condition 226 causes the method to progress to state 208, which ensures that the one or more safety module(s) are enabled and a warning is issued to the driver because of the inactive ignition.

While at state 208 where the engine is running, one or more safety module(s) are enabled, and a warning has been issued to the driver, there are various possibilities for transitioning to other states or issuing particular action commands. For example, if the ignition status becomes inactive AND the vehicle speed is greater than the threshold AND the driver puts the vehicle gear into a non-driving gear (e.g., park, reverse, or neutral), then transition condition 228 may issue an action command that causes the engine to turn off. If the driver or some module in the vehicle, for example, changes the ignition status to an active state AND the engine is running, then transition condition 230 can shift the method from state 208 to state 204; in such a case, the previously issued warnings could be dismissed or retracted. When the method is at state 208, if the ignition status becomes inactive AND the vehicle speed is less than the threshold AND the engine is no longer running, it may be indicative that the ignition status change was intended by the driver, and transition condition 232 could cause the method to shift back to the normal operative state 202. Lastly, if the engine is no longer running (e.g., the engine stalls) AND the vehicle speed is greater than the minimum speed threshold OR the ignition status becomes active, an action command may be issued to restart the counter for the engine restart attempts as part of the transition condition 234, which can direct the method from state 208 to state 206. At state 206, the method will attempt to restart the engine, as described above in greater detail.

The above-described methodologies may be used with both keyed and keyless ignition units and may affect a variety of vehicle control and safety features, not just the power-assisted steering and braking systems mentioned above. The method may be performed or executed wholly or partially within a number of different modules or units (e.g., the control module 50, the ignition unit 60, an engine control module, a brake control module, a steering control module, a body control module or some other module or unit) and may impact numerous vehicle systems, such as an active safety system, a brake or steering control system, or a stability control system, to name a few.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of operating a vehicle control system, comprising the steps:
receiving a plurality of signals at a control module, the plurality of signals include speed signals that are representative of a vehicle speed, ignition signals that are representative of an ignition status, and engine signals that are representative of an engine status;
evaluating the plurality of signals with the control module in order to detect an unintended ignition event, the unintended ignition event is detected when the ignition signals indicate a transition from an active ignition status to an inactive ignition status while the speed signals indicate the vehicle is moving and the engine signals indicate the engine is running; and
preventing the engine from stopping in response to the detection of the unintended ignition event, wherein preventing the engine from stopping extends the availability of one or more vehicle systems that require engine operation.

2. The method of claim 1, wherein the evaluating step further comprises evaluating the plurality of signals with the control module in order to detect an unintended ignition event, the unintended ignition event is detected when the ignition signals indicate a transition in an ignition position of a keyed ignition unit from an active ignition status to an inactive ignition status while the speed signals indicate the vehicle is moving and the engine signals indicate the engine is running.

3. The method of claim 1, wherein the evaluating step further comprises evaluating the plurality of signals with the control module in order to detect an unintended ignition event, the unintended ignition event is detected when the ignition signals indicate a transition from an active ignition status to an inactive ignition status while the vehicle speed is greater than a minimum speed threshold that is stored in memory and the engine signals indicate the engine is running.

4. The method of claim 1, wherein the receiving step further comprises receiving a plurality of signals at the control module, the plurality of signals further include gear signals that are representative of a gear setting; and
the evaluating step further comprises evaluating the plurality of signals with the control module in order to detect an unintended ignition event, the unintended ignition event is detected when the ignition signals indicate a transition from an active ignition status to an inactive ignition status while the speed signals indicate the vehicle is moving, the engine signals indicate the engine is running, and the gear signals indicate the vehicle is in park.

5. The method of claim 1, wherein the receiving step further comprises receiving a plurality of signals at the control module, the plurality of signals further include parking brake signals that are representative of a parking brake status; and
the evaluating step further comprises evaluating the plurality of signals with the control module in order to detect an unintended ignition event, the unintended ignition event is detected when the ignition signals indicate a transition from an active ignition status to an inactive ignition status while the speed signals indicate the vehicle is moving, the engine signals indicate the engine is running, and the parking brake signals indicate the parking brake is not engaged.

6. The method of claim 1, wherein the preventing step further comprises preventing the engine from stopping by sending command signals from the control module in response to detecting the unintended ignition event that keep the engine running.

7. The method of claim 1, wherein the preventing step further comprises preventing the engine from stopping by overriding ignition signals from an ignition unit that are in response to an unintended ignition event.

8. The method of claim 1, further comprising the step of:
attempting to automatically restart the engine when the speed signals indicate that the vehicle is moving and the engine signals indicate that the engine is stopped.

9. The method of claim 8, wherein the attempting step further comprises continuing to attempt to automatically restart the engine until at least one of the following events occurs: the engine is successfully restarted, a driver takes an affirmative action indicating a desire to maintain the engine stopped, or a number of restart attempts exceeds a restart attempt threshold.

10. The method of claim 1, further comprising the step of:
initiating one or more remedial action(s) in response to the detection of the unintended ignition event, the remedial action(s) include at least one action selected from the group consisting of: enabling or keeping enabled a vehicle safety system or issuing a warning to the driver.

11. A method of operating a vehicle control system, comprising the steps:
receiving a plurality of signals at a control module, the plurality of signals include speed signals that are representative of a vehicle speed, ignition signals that are representative of an ignition status, and engine signals that are representative of an engine status;
evaluating the plurality of signals with the control module in order to detect an unintended ignition event, the unintended ignition event is detected when the speed signals indicate the vehicle is moving and the ignition signals indicate the ignition is active yet the engine signals indicate the engine is not running; and
attempting to restart the engine while the vehicle is moving in response to the detection of the unintended ignition event, wherein restarting the engine restores the availability of one or more vehicle systems that require engine operation.

12. The method of claim 11, wherein the evaluating step further comprises evaluating the plurality of signals with the control module in order to detect an unintended ignition event, the unintended ignition event is detected when the vehicle speed is greater than a minimum speed threshold that is stored in memory and the ignition signals indicate the ignition is active yet the engine signals indicate the engine is not running

13. The method of claim 11, wherein the attempting step further comprises attempting to automatically restart the engine by sending command signals from the control module in response to detecting the unintended ignition event that initiate an engine restart procedure.

14. The method of claim 11, wherein the attempting step further comprises continuing to attempt to restart the engine until at least one of the following events occurs: the engine is successfully restarted, a driver takes an affirmative action indicating a desire to maintain the engine stopped, or a number of restart attempts exceeds a restart attempt threshold.

15. The method of claim 11, further comprising the step of:
initiating one or more remedial action(s) in response to the detection of the unintended ignition event, the remedial action(s) include at least one action selected from the group consisting of: enabling or keeping enabled a vehicle safety system or issuing a warning to the driver.

16. A method of operating a vehicle control system, comprising the steps:
receiving a plurality of signals at a control module, the plurality of signals include speed signals that are representative of a vehicle speed, ignition signals that are representative of an ignition status, and gear signals that are representative of a gear setting;
evaluating the plurality of signals with the control module;
when the control module determines that the vehicle speed is greater than a threshold and the ignition status is inactive and the gear setting is in drive, then attempting to restart the engine if it is not operating or keeping the engine running if it is already operating; and
when the control module determines that the vehicle speed is greater than a threshold and the ignition status is active, then attempting to restart the engine if it is not operating or keeping the engine running if it is already operating.
